(19) United States
(12) Patent Application Publication
(10) Pub. No.: US 2021/0319396 A1
(43) Pub. Date: Oct. 14, 2021

(54) SECURE DELIVERY AND BUSINESS SYSTEM AND METHOD

(71) Applicant: Patrick S Harney, Chicago, IL (US)

(72) Inventor: Patrick S Harney, Chicago, IL (US)

(21) Appl. No.: 16/845,013

(22) Filed: Apr. 9, 2020

(51) Int. Cl. G06Q 10/08; G06F 21/32

(52) U.S. Cl. CPC G06Q 10/0833; G06F 21/32

(57) ABSTRACT

Embodiments relate to systems and methods for providing verified delivery of an item. The system includes a delivery system having a database for storing identities of at least one recipient or at least one representative; and one or more delivery confirmation devices communicating with at least the delivery system, the delivery confirmation devices adapted to receive the identities of at least one recipient, the at least one representative, at least one alternative delivery site or at least one alternative signatory. Additionally, the system includes at least one user device including at least one biometric component communicating with at least the delivery system, the at least one biometric component adapted to confirm the identity of at least the at least one representative and transmit such confirmation to at least the delivery system, whereby upon receipt of such confirmation, the delivery system communicates at least one of the identities of at least one recipient, the at least one representative, at least one alternative delivery site and at least one alternative signatory to the delivery confirmation device.

### FIELD OF THE INVENTION

The present invention generally relates to delivery services and in particular to securing delivery and business system and methods using biometric locking systems on smartphones to verify the identity of the recipient of delivery or authorize a business action.

### BACKGROUND OF THE INVENTION

Many different operating system-level smartphone functions, such as mail, text, and video communications may be improved if an operating system-level biometric is included for added security. For example, a user may wish to ensure that communications sent from their mobile device to another person are secure. Such communications involving financial information (e.g., with a bank requesting a transfer of funds between accounts), business trade secrets, health information, personal information, legal information, privileged information, and other types of confidential information should be protected. There is, however, no method or system currently available for providing a simple way to secure those communications.

There is, therefore, a need for securing smartphone communications using biometric locking systems that verify the identity of the intended recipient of a smartphone communication before that communication can be made accessible to be interpreted, read, viewed, or otherwise played or executed.

Delivery services have been utilized for decades. These conventional delivery services require recipients to sign for packages or parcels in order to insure that the intended person received the shipment. With the advent of new technology, the pen-and-paper method of recording the recipient's identity has become obsolete. Presently, many of the delivery services record the signature electronically and store that signature in a central database which may be accessed later by the sender (e.g., through a website) for verification purposes. However, this system of verification still relies on capturing the signature of the recipient and does not verify his identity in any other way.

There are a number of problems that arise when such conventional delivery systems are utilized in secure deliveries. For example, the secure deliveries may be packages that contain precious items (e.g., gems, bonds, secure documents, cash, etc.) or dangerous items (e.g., chemical and biological agents) which are directed to a very specific recipient (e.g., “diamond district” of New York City, brokerage houses, law firms, laboratories, etc.). The mere recording of the recipient's signature may be insufficient in these situations because it does not verify if the intended recipient in fact received the package. Sometimes the recipient may have a designated representative who is authorized to receive and sign for the packages. However, when the authorized representative is absent another individual may simply sign for the authorized representative, thus gaining the access to the contents of the package.

Biometrics have become readily available in smartphones. Initial uses for biometrics (e.g., fingerprint, voice recognition, face recognition) are embodied in specialty third party applications. The use of biometrics to lock and unlock a smartphone are examples of biometric functions that may be built into the operating systems of smartphones currently available on the market.

In prior embodiments of performing a verified, confidential or protected business action, the requester requests a business service or action such as printing a check or access to a restricted file. The system determines if the requester has authority to request the verified business action. If the requester has the authority to perform the business action, the action is performed, i.e., the check is printed or access to a file is allowed. However, if the requester does not have access to perform the business action, he/she is denied. The difficulty arises when a business service must be performed and an authorized individual is not available.

Accordingly, it is an object to provide a system and method to authorize delivery or redirect a delivery in according with one embodiment. It is another object to provide a system and method to allow performing a business action when an authorized individual is not available.

These and other objects will be readily evident upon a study of the specification and the accompanying drawing wherein:

### SUMMARY OF THE INVENTION

Embodiments of the invention relate to a system, method and apparatus for providing verified delivery of an items.

One embodiment relates to a system for providing verified delivery of an item. The system comprises a delivery system having a database for storing identities of at least one recipient or at least one representative; and one or more delivery confirmation devices communicating with at least the delivery system, the delivery confirmation devices adapted to receive the identities of at least one recipient, the at least one representative, at least one alternative delivery site or at least one alternative signatory. Additionally, the system includes at least one user device including at least one biometric component communicating with at least the delivery system, the at least one biometric component adapted to confirm the identity of at least the at least one representative and transmit such confirmation to at least the delivery system, whereby upon receipt of such confirmation, the delivery system communicates at least one of the identities of at least one recipient, the at least one representative, at least one alternative delivery site and at least one alternative signatory to the delivery confirmation device.

Still another embodiment relates to a method for providing verified delivery of an item using a system. The system includes a delivery system including a database for storing identities of at least one recipient or at least one representative; and one or more delivery confirmation devices communicating with at least the delivery system, the delivery confirmation devices adapted to receive the identities of at least one recipient, the at least one representative, at least one alternative delivery site or at least one alternative signatory. The system includes at least one user device including at least one biometric component communicating with at least the delivery system, the at least one biometric component adapted to confirm the identity of at least the at least one representative and transmit such confirmation to at least the delivery system. The method includes registering a recipient prior to delivering an item, including registering at least one biometric data of the recipient on the at least one user device; scanning an identifier of the item using the delivery confirmation device; notifying the at least one recipient of impending delivery of the item using the at least one user device; receiving delivery instructions regarding the item using the delivery confirmation device; providing delivery authorization including authentication of the at least one biometric data using the at least one user device; and delivering the item via the delivery instructions.

Still other embodiments relate to a method for providing verified delivery of an item. The method includes registering a recipient prior to delivering an item, including registering at least one biometric data of the recipient on a smart phone; scanning an identifier of the item; notifying a recipient of impending delivery of the item; receiving delivery instructions regarding the item; providing delivery authorization including authentication of the at least one biometric data; and delivering the item via the delivery instructions.

One or more embodiments include the at least one user device comprises a mobile device adapted to communicate wirelessly with the delivery system (a smart phone for example). In one or more embodiments, the at least one biometric component comprises at least one fingerprint recognition component, palm recognition component, voice recognition component, retina scan component, face scan component, input recognition pattern component, body temperature recognition component, or location positioning component. Embodiments include at least one biometric component enables at least one recipient or at least one representative to input, authenticate, and store their own biometrics.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 depicts a block diagram illustrating a prior art method of delivering a package;

FIG. 2 depicts a block diagram illustrating a secure method of delivering a package in accordance with one embodiment of the invention;

FIG. 3 depicts a user device used with the method of delivering a package providing notification of an impending delivery in accordance with one embodiment of the invention;

FIG. 4 depicts a user device used with the method of delivering the package providing notification of a confirmed identification in accordance with one embodiment of the invention;

FIG. 5 depicts a block diagram illustrating a secure method of requesting a service in accordance with one embodiment of the invention;

FIG. 6 depicts a flow diagram illustrating a secure method of requesting a service in accordance with one embodiment of the invention;

FIG. 7 depicts a user device used with the method of requesting a service providing notification of a service request in accordance with one embodiment of the invention; and

FIG. 8 depicts a user device used with the method of delivering the package providing notification of a confirmed identification in accordance with one embodiment of the invention.

Throughout the various figures, like reference numbers refer to like elements.

### DETAILED DESCRIPTION OF PRESENTLY PREFERRED EMBODIMENTS

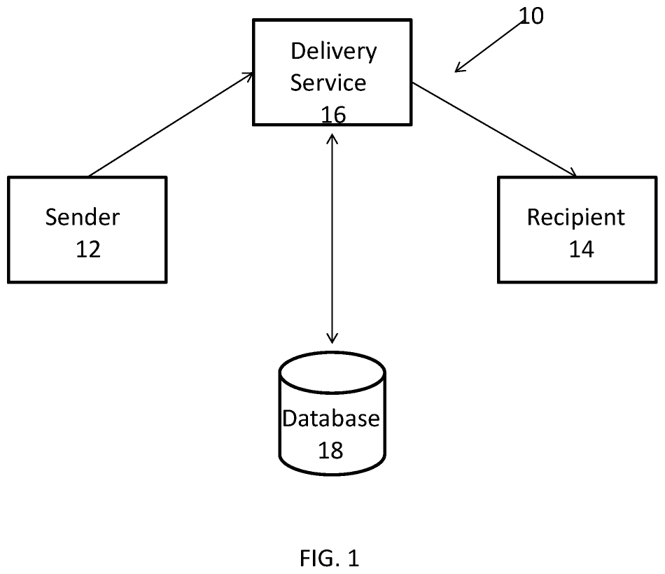

Embodiments of the invention relate to an apparatus, system and method for providing verified delivery of an item. FIG. 1 depicts an exemplary block diagram for delivering a package, generally designated 10, from sender 12 to a recipient 14 using a delivery service 16. First, the sender 12 prepares the merchandise for shipment by placing it in a package and attaching a delivery label which may include delivery instructions, such as the package must only be delivered to the designated recipient 14. In addition, the sender 12 may specify which representative(s) of the recipient 14 are authorized to receive and sign for the package.

The sender 12 submits the package to the delivery service 16 (e.g., the sender 12 either drops off the package at a specified location or the delivery service 16 picks up the package directly from the sender 12). The delivery service 16 may be any local, nationwide or worldwide parcel or mail service (e.g., UPS, USPS, and the like). The delivery service 16 is notified (e.g., via the special packaging or the label) that the package may be delivered only to the authorized representative(s). Upon obtaining the package from the sender 12, the delivery service 16 inputs the identities of the authorized representative(s) into the database 18. The package then travels through the distribution network of the delivery service 16 to a local branch office near which the recipient 14 is located. Once the package reaches the recipient 14, the delivery service 16 attempts to deliver the package.

As mentioned above, the recipient 14 may be any entity that regularly receives packages. The recipient 14 may designate representative(s) who are authorized to receive the packages. In this instance the authorized representative(s) are identified by registered with the delivery service 16. In particular, identification data (i.e., no signature) of the authorized representative(s) is obtained and stored in the database 18.

During delivery of the package, the delivery service 16 may obtain the signature of the authorized representative(s) for verification purposes. The identity of the authorized representative is verified by comparing the biometric identifier obtained using the scanning device to the identification data stored in the database. If the identifier matches the stored identified data then the delivery service 16 releases the package to the authorized representative.

Embodiments of the present invention include systems and methods for using existing biometric unlocking systems of mobile devices to verify the identity of the recipient of a package. The present invention is directed at a system and method for a biometric verification of a recipient's identity upon delivery of the shipment by a delivery service. In at least one embodiment, it is the mobile device (using the biometric unlocking system for example) that confirms the recipients identify, and not the delivery systems apparatuses or systems.

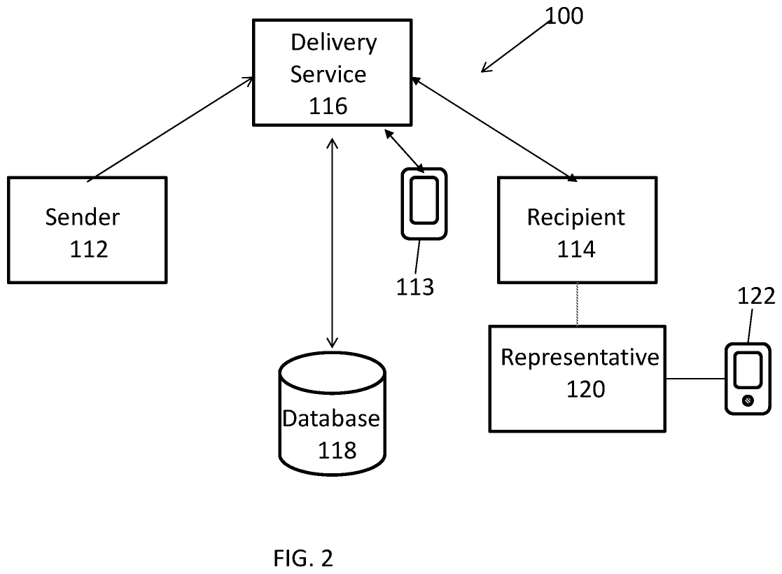

FIG. 2 depicts an exemplary block diagram of a system for delivering a package, generally designated 100, from sender 112 to a recipient 114 using a delivery service 116. The sender 112 may be a particular entity that needs to ship a package. First, the sender 112 prepares the merchandise for shipment by placing it in a package and attaching a delivery label which may include delivery instructions, such as the package may only be delivered to the designated recipient 114. In addition, the sender 112 may specify which representative(s) of the recipient 114 are authorized to receive and sign for the package.

The sender 112 submits the package to the delivery service 116 (e.g., the sender 112 either drops off the package at a specified location or the delivery service 116 picks up the package directly from the sender 112). The delivery service 116 is notified (e.g., via the special packaging or the label) that the package may be delivered only to the authorized representative(s) of recipient 114. Upon receiving the package from the sender 112, the delivery service 116 inputs the identities of the authorized representative(s) 120 into the database 118. The package then travels through the distribution network of the delivery service 116 to a branch office near which the recipient 114 is located. Once the package reaches the recipient 114, the delivery service 116 will attempt to deliver the package.

Part of attempting to deliver the package includes notifying the recipient 114 that the package is ready to be delivered. This may include simply knocking on the recipient's 114 door, ringing a doorbell, walking into the recipient's 114 office, calling the recipient 114, emailing the recipient 114, texting the recipient 114, and the like. Upon reaching the recipient 114, the package still must be released to and/or signed for by the authorized representative(s) 120.

In at least one embodiment depicted in FIG. 2, the system 100 includes one or more delivery confirmation devices 113 communicating with at least the delivery service 116. The delivery confirmation devices 113 are adapted to scan the package, receive the identities of at least one recipient, the at least one representative, at least one alternative delivery site, at least one alternative signatory among other functions.

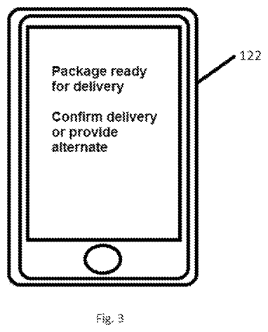

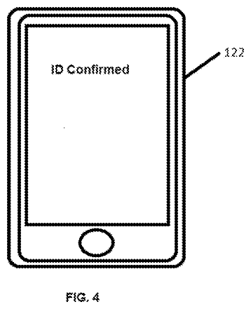

In at least one embodiment, the identity of the authorized representative(s) 120 is verified using a biometric identifier obtained using existing biometric unlocking or identifying technology of the user device 122 (similar to that depicted in FIGS. 3-4). FIG. 3 depicts a notice sent to the user device 122 requesting confirmation of alternate delivery or alternate signatory for example. If the identity of the user having the user device 122 matches the identity of the authorized representative(s) 120 in the database 118 (as provided in FIG. 4), the delivery service 16 may deliver the package to the alternate delivery site or release the package into possession of the alternate signatory.

User devices 122 may include any type of mobile phone, PDA and smartphone, such as iPhone™, Android™ devices and the like. User devices 122 may include any type of tablet or mobile computers, such as Apple iPads™, Windows Surfaces™ and the like. Additionally, user devices 122 may include any type of Laptops/desktops, such as portable or stationary computers like Macbooks and PCs. User devices 122 may include set-top boxes that, inter alia, convert digital television signals to analog for viewing on a conventional set, or that enable cable or satellite television to be viewed. In certain embodiments of the invention, the set-top boxes may include a television or satellite recipient.

User devices 122 include biometric components (e.g., fingerprint recognition, palm recognition, voice recognition, retina scan, face scan, input recognition pattern, body temperature recognition, location positioning, and the like) that provide their users with the ability to input, authenticate, and store their own biometrics. In some embodiments, an installable or downloadable application may provide additional options for managing or using such biometric data, including the uses described herein. In at least one embodiment, the user devices 122 may further include a fingerprint recognition component. The fingerprint recognition component may be a button on a smartphone that unlocks the smartphone only when a user fingerprint matches a stored fingerprint.

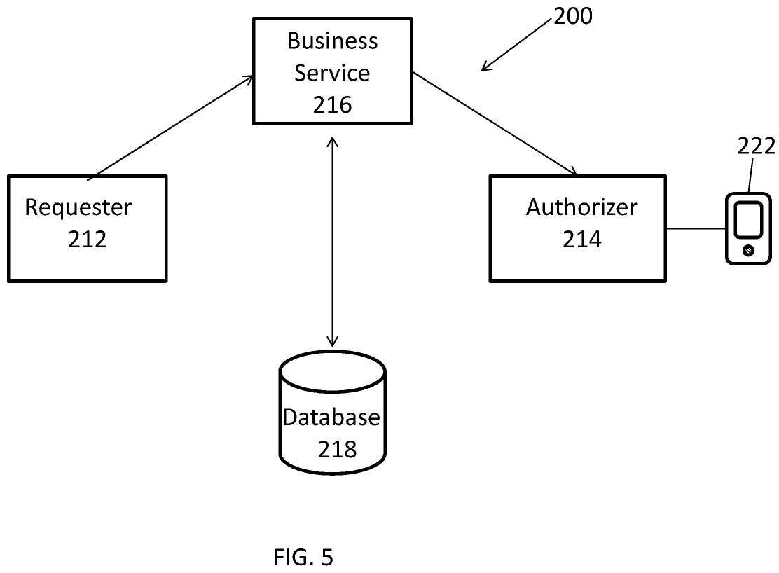

In an alternative embodiment of the invention, the requester requests a confidential or protected business action, such as printing a check or access to a restricted file. FIG. 5 depicts an exemplary block diagram for requesting a confidential or protected business action, generally designated 200, from requester 212 to an authorizer 214 using a business service 216. The requester 212 may be a particular entity that requires a service, secretary, assistant or coworker for example. First, the requester 212 requests the service, i.e., a check be printed or access to a file, from the business service/action device 216.

The system 200 determines if the requester 212 has authority to request the verified business action via information stored in database 218 for example. If the requester has the authority to perform the business action, the action is performed, i.e., the check is printed or access to a file is allowed for example. If the requester does not have authority to perform the business action, system 200 quires the authorizer 214 for such authorization is verified by the user device 212 for example.

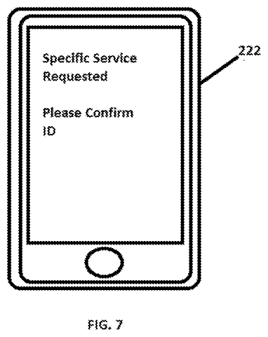

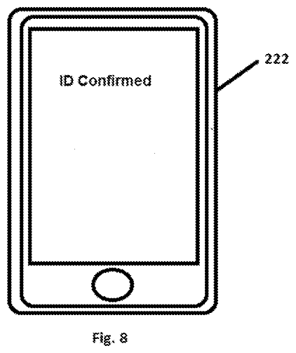

In at least one embodiment, the identity of the authorizer 214 is verified using a biometric identifier obtained using existing biometric unlocking or identifying technology of the user device 222 (similar to that depicted in FIGS. 7-8). FIG. 7 depicts a notice sent to the authorizer 214 via user device 212 requesting authorization of the protected business action. If the identity of the user having the user device 222 matches the identity of the authorized individuals in the database 218 (as provided in FIG. 8), the business protected action is authorized.

User devices 222 may include any type of mobile phone, PDA and smartphone, such as iPhone™, Android™ devices and the like. User devices 122 may include any type of tablet or mobile computers, such as Apple iPads™, Windows Surfaces™ and the like. Additionally, user devices 222 may include any type of Laptops/desktops, such as portable or stationary computers like Macbooks and PCs. User devices 222 may include set-top boxes that, inter alia, convert digital television signals to analogue for viewing on a conventional set, or that enable cable or satellite television to be viewed. In certain embodiments of the invention, the set-top boxes may include a television or satellite recipient.

User devices 222 include biometric components (e.g., fingerprint recognition, palm recognition, voice recognition, retina scan, face scan, input recognition pattern, body temperature recognition, location positioning, and the like) that provide their users with the ability to input, authenticate, and store their own biometrics. In some embodiments, an installable or downloadable application may provide additional options for managing or using such biometric data, including the uses described herein. In at least one embodiment, the user devices 222 may further include a fingerprint recognition component. The fingerprint recognition component may be a button on a smartphone that unlocks the smartphone only when a user fingerprint matches a stored fingerprint.

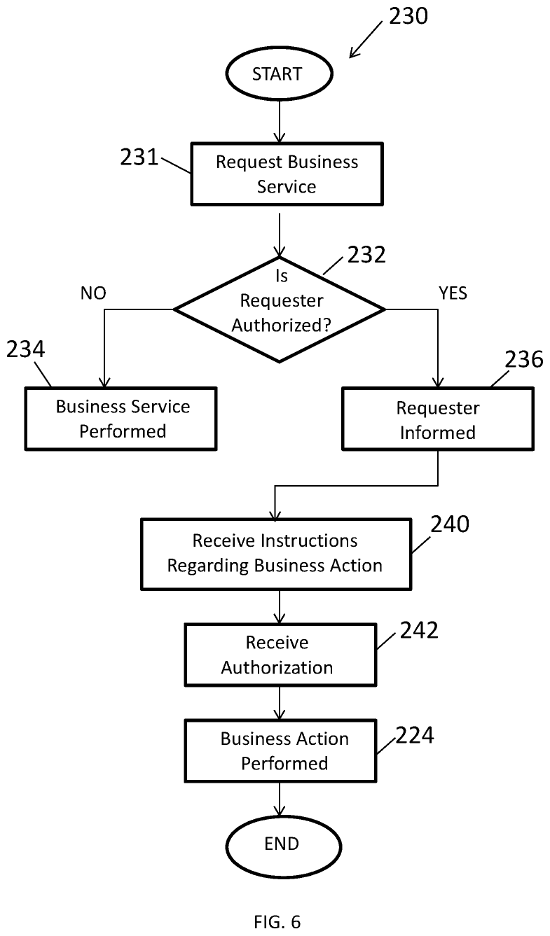

FIG. 6 depicts an exemplary block diagram for providing a verified business action, generally designated 230. In the present embodiment, the requester requests a business service or action such as printing a check or access to a restricted file, block 231. The method 230 accesses database/system to determine if the requester has authority to request the verified business action, block 232. If the requester has the authority to perform the business action, the action is performed, block 234. If the requester does not have access to perform the business method, an authorizer of the impending business action is notified, block 236.

Method 230 further includes receiving instructions regarding the business action, block 240. The method 230 further includes receiving action authorization including authentication of the at least one biometric data, from the authorizer using a smartphone for example, block 242. The system then performs the business action via the instructions, block 244.

In at least one embodiment, the authorizer is registered prior to performing the business action, including registering at least one biometric data of the authorizer on a smartphone, including any of the biometric data provided above. Additionally, the requester may be registered prior to performing the business action, including registering at least one biometric data of the requester on a smartphone, including any of the biometric data provided above. In one or more embodiments, the biometric data may be used to sign a, such as a contract, check and the like

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. (canceled)

2. (canceled)

3. (canceled)

4. (canceled)

5. (canceled)

6. (canceled)

7. A method for providing verified delivery of an item using a system, the system comprising:
a delivery system including a database for storing identities of at least one recipient or at least one representative;
one or more delivery confirmation devices communicating with at least the delivery system, the delivery confirmation devices adapted to receive the identities of at least one recipient, the at least one representative, at least one alternative delivery site or at least one alternative signatory; and
at least one user device including at least one biometric component communicating with at least the delivery system, the at least one biometric component adapted to confirm the identity of at least the at least one representative and transmit such confirmation to at least the delivery system;
the method comprising registering a recipient prior to delivering an item, including registering at least one biometric data of the recipient on the at least one user device;
scanning an identifier of the item using the delivery confirmation device;
notifying the at least one recipient of impending delivery of the item using the at least one user device;
receiving delivery instructions regarding the item using the delivery confirmation device;
providing delivery authorization including authentication of the at least one biometric data using the at least one user device; and
delivering the item via the delivery instructions.

8. The method of claim 7 wherein the at least one user device comprises a mobile device.

9. The method of claim 8 wherein the mobile device is adapted to communicate wirelessly with the delivery system.

10. The method of claim 7 wherein the at least one user device comprises a smart phone.

11. The method of claim 7 wherein the at least one biometric component comprises at least one fingerprint recognition component, palm recognition component, voice recognition component, retina scan component, face scan component, input recognition pattern component, body temperature recognition component, or location positioning component.

12. The method of claim 7 wherein the at least one biometric component enables at least one recipient or at least one representative to input, authenticate, and store their own biometrics.

13. A method for providing verified delivery of an item, comprising:
registering a recipient including recoding at least one biometric data of the recipient on smart phone hardware;
scanning an identifier of the item using a delivery confirmation device communicating with a delivery system;
storing the identified in a database of the delivery system;
notifying the recipient of impending delivery of the item using the smart phone;
receiving delivery instructions from the smart phone regarding delivery of the item;
communicating delivery authorization from the smart phone to the delivery confirmation device including authentication of the at least one biometric data stored on the smart phone hard ware; and
delivering the item via the delivery instructions.

14. The method of claim 13 wherein notifying the recipient of impending delivery of the item using the smart phone includes the delivery system communicating with the smart phone.

15. The method of claim 13 wherein receiving the delivery instructions from the smart phone regarding delivery of the item comprises the smart phone communicating with the delivery system.

16. The method of claim 15 wherein receiving the delivery instructions further comprises the delivery system communicating with the delivery confirmation device.

17. The method of claim 13 wherein the at least one biometric component comprises at least one fingerprint recognition component, palm recognition component, voice recognition component, retina scan component, face scan component, input recognition pattern component, body temperature recognition component, or location positioning component.
